(19) United States
(12) Patent Application Publication
(10) Pub. No.: US 2005/0289620 A1
(43) Pub. Date: Dec. 29, 2005

(54) Method and apparatus for generating an application data signal

(75) Inventor: Paul Andrew Bristow, Suresnes (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,842

(22) PCT Filed: Nov. 6, 2003
(86) PCT No.: PCT/IB03/05022

§ 371 Date: May 31, 2005

(30) Foreign Application Priority Data
Dec. 4, 2002 (EP) 02292993.9

(51) Int. Cl. H04N 7/173

(52) U.S. Cl. 725/100; 725/131

(57) ABSTRACT

The invention relates to a system for generating an application data signal from content signals having embedded application data The content signal may be an MPEG 2 encoded TV signal. A storage device (111) comprises a receiver (115) which receives the content signal from an external source. An extraction processor (117) extracts the application data from the content signal and independently stores both in a data storage (119, 121). An application data generator (127) is operable to generate an application data signal by retrieving the stored application data from the data storage separately from the content signal. Thus the application data signal may be processed or communicated independently of the content signal.

The invention relates to a method and apparatus for generating an application data signal and in particular to generating an application data signal for interactive applications associated with an audiovisual content stream.

In recent years, the availability, diversity and quantity of electronic home entertainment services have increased dramatically. For example, an increasing amount of TV broadcast services have been introduced including additional TV stations, channels and programmes. Furthermore, in addition to the traditional analogue terrestrial broadcasts, TV services are increasingly being provided over alternative communication links including for example satellite broadcasts and direct electrical or optical cable connections.

In particular, digital encoding and distribution of content signals have become increasingly predominant. This includes for example the emergence of digitally encoded and distributed TV signals or radio broadcasts. Typically, digital TV services, such as satellite broadcast TV, use MPEG 2 encoded TV signals to achieve an improved picture and sound quality at reasonable transmission rates.

The possibilities of the service provider for providing services more specifically aimed at individual users are substantially increased for digital services. Specifically, it allows for increasing non content data to be communicated and this may be directed towards a single user or a group of users. Additionally, data may be broadcast which can be processed in a TV receiver to provide additional services. Specifically, interactive TV services may be provided, allowing the user to influence the viewing of a TV programme or to receive, identify and select information of specific interest.

An example of an interactive TV service is where a plurality of video streams is broadcast covering different camera angles whereby the user may switch between these video signals according to his preference. For example, a football match is typically covered by many different cameras. In addition to the typical edited transmission, a second stream focussing on a specific player may be transmitted allowing the user to interactively select between the typical overview and focussing on the specific player.

Hence, it is now commonplace for digital broadcast signals to comprise data related to additional services such as interactive services. This data is typically embedded in the broadcast transmission data. For example, a system known as Multimedia Home Platform has been standardised by the European Telecommunication Standards Institute (ETSI) wherein application data for e.g. interactive services are embedded within an MPEG 2 encoded signal stream. The application data is repeatedly inserted in the encoded signal stream such that it is repeatedly available for an MHP terminal. The MHP terminal is able to retrieve the data from the broadcast stream. The retrieved application data is processed to provide the corresponding interactive application. MHP thus enables additional services to be provided based on a single broadcast signal.

However, the application data of systems such as MHP are embedded in the content signal typically by being time multiplexed with the encoded audio visual signal. Consequently, the application data is only present during relatively short intervals of the data stream. This significantly reduces the available data rate of the application data. It furthermore tends to increase delays due to the data not being continuously available as well as to the reduced data rate. Further, the conventional approach of embedding application data in the encoded signal stream is relatively inflexible. For example, in order for a terminal to access the application data, it is necessary to process the full data stream in order to retrieve the application data. It furthermore tends to increase complexity as distribution and storage is performed for the combined high data rate signal.

Hence, an improved system for generating an application data signal would be advantageous. In particular, a system for generating an application signal allowing for increased flexibility, reduced complexity, reduced delay, and/or increased data rate would be advantageous.

Accordingly, the Invention seeks to mitigate, alleviate or eliminate one or more of the above mentioned disadvantages singly or in any combination.

According to a first aspect of the invention there is provided an apparatus for generating an application data signal; the apparatus comprising: a receiver for receiving a content signal comprising embedded application data; an extraction processor for extracting the application data from the content signal; a data storage for storing the content signal and the application data; and an application data generator for generating an application data signal by retrieving the stored application data from the data storage separately from the content signal.

The content signal may for example comprise audiovisual content such as TV programmes. Preferably, the content signal is a video signal and/or an audio signal and may specifically be an MPEG 2 encoded audiovisual content signal comprising embedded application data The extraction of application data from the content signal is preferably prior to storage in the data storage. However, the extraction may for example also be performed in association with the retrieval process. Thus, for example, the application data generator may retrieve the stored application by retrieving a combined signal and discarding the non application data part. The extraction of application data from the content signal may remove at least some of the application data from the content signal, or may copy the application data thereby leaving the application data embedded in the content signal.

The invention allows for application data and content signal to be processed and manipulated independently following storage. This allows for increased flexibility and reduces the complexity of processing of one or both of the application data and the content signal. Consequently, reduced data rate and reduced delays may be achieved.

According to a feature of the invention, the apparatus further comprises a communication processor operable to communicate the application data signal at a data rate higher than an average application data rate of the content signal. This allows for an increased data rate of communication and/or distribution of the application data resulting in reduced delays.

According to another feature of the invention, the content signal is an interactive audiovisual signal and the application data is interactive application data, and preferably the interactive audiovisual signal is a broadcast interactive TV signal. Accordingly, a flexible, low complexity and/or low delay system for interactive services and specifically for broadcast interactive TV services are enabled.

According to another feature of the invention, the extraction processor comprises means for storing the application data and content data of the content signal separately in the data storage. Preferably, the content signal and application data are stored separately thereby allowing the storage, access and/or retrieval parameters, characteristics and algorithms to be optimised for each type of data.

According to another feature of the invention, the extraction processor is operable to modify an application data indication of the content signal. Preferably, the extraction processor modifies the application data information to reflect any modifications made to the application data embedded in the content signal thereby enabling a receiver of the modified content signal to process the modified content signal accordingly.

According to another feature of the invention, the extraction processor is operable to modify the application data indication of the content signal by removing a data indication related to application data that has been removed from the content signal. Specifically, application data indications associated with embedded application data that has been removed from the content signal is deleted, thereby preventing a receiver attempting to access non-existent data.

According to another feature of the invention, the extraction processor is operable to modify the application data indication of the content signal to be associated with the application data stored in the data storage. Preferably, an application data indication may be changed from pointing to application data within the content signal to pointing to application data in the data storage. This allows for an efficient and low complexity method of accessing the stored application for a processor receiving the content signal.

According to another feature of the invention, the extraction processor is operable to modify the application data indication of the content signal to comprise a network server identity through which the application data signal can be accessed. This allows for a convenient and advantageous method of accessing the application data in the data storage. Especially for a remote terminal receiving the content signal through a limited communication link, the application data may conveniently be accessed through a suitable network based on the network server identity.

According to another feature of the invention, the extraction processor is operable to remove at least some of the application data from the content signal. This allows for the content signal to be reduced and may for example reduce the data rate of the content signal or free up space for other data including other application data. Specifically, this may allow for an increased repetition rate of other application data embedded in the content signal.

According to another feature of the invention, the apparatus is a digital recording device. Hence, the invention allows for a digital recording device that may provide the stored content signal as well as providing an improved application data signal. Hence, the application data for e.g. interactive services may be accessed faster and more flexibly by a content presentation device when the content signal has been stored relative to when being received in real time.

According to another feature of the invention, the extraction processor is operable to store the content signal and the application data in the data storage according to different storage protocols. The storage protocols may be optimised for each individual data type thus providing increased performance and flexibility. For example, the application data may be accessed through different access mechanisms optimised for application data The organisation of the storage of the different types of data may be different. For example, the content signal may be stored in a way suitable for continuous and sequential storage and retrieval of data whereas the application data may be organised in a hierarchical way facilitating access to individual data elements of the application data.

According to another feature of the invention, the apparatus further comprises communication element for communicating the application data signal and the content signal according to different communication protocols. For example, a remote content presentation device requires a communication link with the data storage that has a minimum available data capacity throughout the presentation of the content signal. However, the application data signal may only need to be communicated once and may therefore be provided at a much higher data rate but for a shorter time interval through a high data rate time multiplexed data network. Hence, the communication may be individually optimised for the content signal and the application data signal.

According to a second aspect of the invention, there is provided a method of generating an application data signal; the method comprising: receiving an content signal comprising embedded application data; extracting the application data from the content signal; storing the content signal and the application data; generating an application data signal by retrieving the stored application data separately from the content signal.

These and other aspects of the invention will be apparent from and elucidated with reference to the embodiment(s) described hereinafter.

An embodiment of the invention will be described, by way of example only, with reference to the drawings, in which

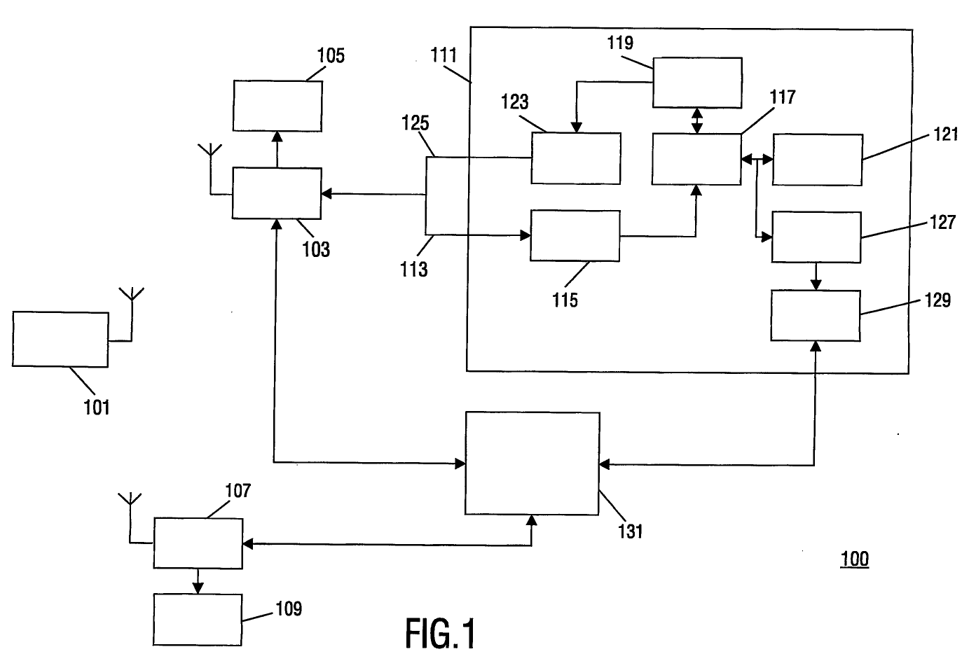

FIG. 1 is an illustration of a broadcast system for interactive TV comprising a digital recorder in accordance with an embodiment of the invention; and

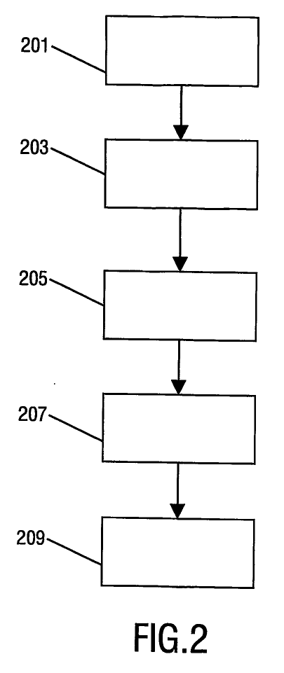

FIG. 2 is an illustration of a method of generating an application signal in accordance with an embodiment of the invention.

The following description focuses on an embodiment of the invention applicable to a digital audiovisual recorder and in particular to a recorder for interactive TV. However, it will be appreciated that the invention is not limited to this application but may be applied to many other devices and systems.

FIG. 1 is an illustration of a broadcast system 100 for interactive TV comprising a digital recorder in accordance with an embodiment of the invention.

The broadcast system 100 comprises a interactive digital TV broadcast transmitter 101 broadcasting a number of interactive TV channels over a terrestrial radio communication medium. The TV signals are received by a digital TV terminal 103 which comprises functionality for receiving the broadcast radio signals and retrieving the broadcast content stream therefrom. The TV terminal 103 thus derives a digitally encoded content signal from the received signal. The TV terminal 103 is connected to a display device 105 which in the preferred embodiment is a conventional TV monitor. The TV terminal and display device thus together form a presentation device operable to present real time content signals received from the TV broadcast transmitter.

The display device and the TV terminal may be an integrated unit or the functionality may be distributed over two or more different units. In the preferred embodiment, the TV terminal is a Multimedia Home Protocol (MHP) set top box. The TV terminal is further operable to retrieve application data from the received TV signals, and specifically to retrieve interactive TV data, which it is further operable to process in order to provide interactive TV services. For example, the broadcast TV signal may comprise a broadcast stream of an MPEG2 encoded audiovisual signal. The encoded audiovisual signal may comprise text information related to e.g. news events. The TV terminal may be operable to retrieve this data and present it to a user in response to received user inputs. Other examples of interactive applications include dynamic selection of camera angles, email services, two way text based communication (chat services) and provision of additional information related to the content of the received signal.

In addition to the first TV terminal 103, FIG. 2 shows a second TV terminal 107 with an associated display device 109. The second TV terminal 107 may be identical to the first TV terminal 103 or may be a different type or category of TV terminal operable to receive the broadcast signal from the TV broadcast receiver. Typically, a broadcast system comprises a high number of TV terminals.

The first TV terminal is connected to a storage device 111. The storage device 111 is operable to record digital TV programmes received from the TV terminal. Specifically, the digital recording device 111 may be a digital recording device such as a Personal Video Recorder or a removable storage medium based recorder such as a DVD recorder. The storage device 111 is connected to the TV terminal over a dedicated communication line 113 which in the preferred embodiment comprises a direct physical optical or electrical cable carrying the broadcast stream derived by the TV terminal 103. The storage device 111 comprises a receiver 115 capable of receiving the broadcast stream from the TV terminal. In the preferred embodiment, the MPEG 2 encoded content signal with embedded application data is transmitted to the receiver 115 through the communication line 113.

The receiver 115 is coupled to an extraction processor 117 which is further coupled to a first memory 119 and a second memory 121. Hence, in the preferred embodiment, the storage device 111 comprises a data storage comprising the first and second memory 119, 121. The data storage may preferably be a single hard disk, and the first and second memory may be implemented as different memory partitions of that hard disk.

The extraction processor 117 is operable to process the received broadcast stream and to store data therefrom in the first and second memory 119, 121. The extraction processor 117 is further operable to extract application data from the content data. Hence, in the preferred embodiment, the extraction processor 117 extracts the application data related to interactive services from the MPEG 2 encoded content signal. The content signal is then stored in the first memory 119 whereas the application data is stored in the second memory 121. In the preferred embodiment, the application data is not removed from the content signal but is copied and separately stored in the second memory 121. This allows application data to be accessed either through retrieval of the content signal or through direct retrieval of the application data from the second memory 121.

The storage device 111 further comprises a broadcast signal generator 123 coupled to the first memory 119. The broadcast signal generator 123 has functionality for retrieving a stored content signal and communicating this to the TV terminal 103 over a second communication line 125. Hence, the storage device 111 can record a content signal received from the TV terminal 103 for later retransmission to and presentation by the TV terminal.

In addition, the storage device 11 comprises an application data generator 127 coupled to the second memory 121 and operable to retrieve stored application data from the second memory 127. Hence, the application data generator 127 retrieves the stored application data separately from the content signal. The application data generator 127 generates an application data signal comprising the retrieved application data. The application data signal may subsequently be accessed by or transmitted to any suitable processing unit in any suitable way. Thus, the process may be optimised specifically for the requirements related to the application data rather than be constrained by the requirements for a content stream or signal.

In the preferred embodiment, the storage device 111 comprises a communication processor 129, which is operable to transmit an application data signal to external devices and specifically to the TV terminal 103. The communication processor 129 can communicate the application data signal at a data rate which is higher than an average application data rate of the content signal. Specifically in the example of FIG. 1, the TV terminal 103 and storage device 111 are interconnected through a network 131 and the communication processor 129 is capable of communicating the application data to the TV terminal through this network 131.

The network 131 may be a Local Area Network (LAN) or may specifically be the Internet. The communication processor 129 comprises functionality associated with a network server. Further, other TV terminals 107 and storage devices may be connected to the network 131 and communicate through this. The network 131 is thus, in the preferred embodiment, a time multiplexed network shared between many users and having a high instantaneous throughput rate. Hence, the TV terminal 103 may access or be provided with application data at a high data rate and low delay. The access to application data by the TV terminal is thus not constrained by the requirements and limitations of the content signal and the embedding of data therein.

FIG. 2 is an illustration of a method of generating an application signal in accordance with an embodiment of the invention. The method will be described with reference to the broadcast system of FIG. 1.

In step 201, the storage device 111 receives a content signal comprising embedded application data. The content signal is in the preferred embodiment an MPEG 2 encoded audiovisual signal received from an MHP terminal and comprising embedded interactive application data.

The method proceeds in step 203, wherein the extraction processor 117 extracts the application data from the content signal. The extraction is in the preferred embodiment a copying process wherein the application data is copied but not removed from the content signal.

In step 205, which follows step 203, the content signal and the application signals are stored. Specifically, the content signal is stored in the first memory 119 and the application data is stored in the second memory 121.

Step 205 is followed by step 207 wherein the data generator 127 generates an application data signal by retrieving the stored application data separately from the content signal. In the preferred embodiment, the data generator simply retrieves the desired application data from the second memory 121.

The application data signal may consequently be processed or communicated according to any suitable process, and in the preferred embodiment, step 209, which follows step 207, comprises communicating the application signal to a presentation device through a high data rate communication network.

In the preferred embodiment, both the content signal and the application data signal may be communicated to a presentation device. In this embodiment, the storage device 111 comprises a communication element for communicating the application data signal and the content signal according to different communication protocols. The communication links or means used for communicating the content signal and the application data signal may be the same used with different protocols, or may be different means typically having different properties and characteristics. For example, in the example of FIG. 2, the communication element comprises the broadcast signal generator 123, which communicates the content signal to the TV terminal 103 over a dedicated communication line 125. In addition, the communication element comprises the communication processor 129, which communicates the application data signal to the TV terminal 103 over a shared network using a different communication protocol.

It will be appreciated that in different embodiments, the order of the steps may be different than described above. For example, the content signal and the application data may be stored as the received content signal. The extraction of the application data from the content signal may be performed during the process of retrieving the content signal from a data storage. Thus, in this case the application data generator retrieves the application data separately from the content signal by retrieving the content signal from the data storage, extracting the application data and consequently discarding the content signal (or separately processing or providing the content signal for processing).

In the preferred embodiment described above, the application data is not removed from the content signal. However, in other embodiments at least some of the application data is removed. For example, in one such embodiment all the application data that is separately stored in a memory is removed from the content signal. In this specific embodiment, the application data, which is removed, may replaced by other application data relating to other applications or by new content data but is preferably not replaced, whereby a reduction in the data rate of the content signal may be achieved.

In some embodiments, an application data indication of the content signal is modified by the storage device and preferably by the extraction processor. In one such embodiment, the application data indication is modified such that any reference to application data that has been separately stored and/or removed from the content signal is modified. The reference may be deleted altogether, or may e.g. be modified to refer to dummy application data.

However, preferably, the application data indication is modified such that a reference to application data, that has been extracted and stored separately, is modified to refer directly to the appropriate storage parameters for the data. Thus for an MPEG 2 signal, the storage device will rewrite the Application Information Table (AIT) within the MPEG 2 encoded content stream such that it will point to the corresponding application data in the data storage. The reference may for example be a specific physical or logical location on a hard disk which is part of the data storage.

In some embodiments the storage device comprises functionality for operating as a network server that can provide requested application data over a network. Specifically, the storage device may implement the required functionality for a http (HyperText Transfer Protocol) server. Thus the storage device may be accessible as a server over the Internet or any other IP-based network, and a terminal may access the application data through access of an Internet based server. In some of these embodiments, the application data indication may specifically be modified such that it comprises the identity of the network server implemented in the storage device. The application data indication may thus include the IP (Internet Protocol) address of the server of the storage device.

In the preferred embodiment described above, the application data and content signal are stored in separate memory. However, it will be clear that any suitable storage medium and method may be used without detracting from the invention. For example different methods of storage may be used whereby the retrieval process allows for application data to be obtained separately from the content signal. In one embodiment, a single memory structure is used and application data and content signals are simply stored in different files.

However, preferably the content signal and application data is stored according to different storage protocols. For example, the content signal may be stored in a format and structure particularly suitable for sequential retrieval, for example by a Direct Memory Access (DMA) operation. In contrast, the application data may be stored according to a storage protocol allowing for individual data elements to be easily located and accessed. Thus, a hierarchical storage protocol may preferably be used for application data.

It will be appreciated that the above description for clarity has described embodiments of the invention with reference to different functional units of the storage device. However, it will be apparent that any suitable distribution of functionality between different functional units may be used without detracting from the invention. Hence, references to specific functional units are only to be seen as references to suitable means for providing the described functionality rather than indicative of a strict logical or physical structure, organisation or separation. For example, the application data generator may be integrated and intertwined with the extraction processor or may be a part of this.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

It will be appreciated that the invention tends to provide one or more of the following advantages singly or in any permutation or combination:
It allows for optimisation of application data processes and communication independently of requirements and restrictions relevant to content signals.
Delays associated with application data access may be significantly reduced.
Application data may be accessed at high data rates.
It allows for reduced processing complexity of application data.

Further advantages will be apparent from the above description.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

In general, the invention relates to a system for generating an application data signal from content signals having embedded application data. The content signal may be an MPEG 2 encoded TV signal. A storage device (111) comprises a receiver (115) which receives the content signal from an external source. An extraction processor (117) extracts the application data from the content signal and independently stores both in a data storage (119, 121). An application data generator (127) is operable to generate an application data signal by retrieving the stored application data from the data storage separately from the content signal. Thus the application data signal may be processed or communicated independently of the content signal.

1. An apparatus for generating an application data signal; the apparatus comprising:
a receiver for receiving a content signal comprising embedded application data;
an extraction processor for extracting the application data from the content signal;
a data storage for storing the content signal and the application data; and
an application data generator for generating an application data signal by retrieving the stored application data from the data storage separately from the content signal.

2. An apparatus as claimed in claim 1 wherein the apparatus comprises a communication processor operable to communicate the application data signal at a data rate higher than an average application data rate of the content signal.

3. An apparatus as claimed in claim 1 wherein the content signal is a video signal.

4. An apparatus as claimed in claim 1 wherein the content signal is an audio signal.

5. An apparatus as claimed in claim 1 wherein the content signal is an MPEG 2 encoded content signal.

6. An apparatus as claimed in claim 1 wherein the content signal is an interactive audiovisual signal and the application data is interactive application data.

7. An apparatus as claimed in claim 6 wherein the interactive audiovisual signal is a broadcast interactive TV signal.

8. An apparatus as claimed in claim 1 wherein the extraction processor comprises means for storing the application data and content data of the content signal separately in the data storage.

9. An apparatus as claimed in claim 1 wherein the extraction processor is operable to modify an application data indication of the content signal.

10. An apparatus as claimed in claim 9 wherein the extraction processor is operable to modify the application data indication of the content signal by removing a data indication related to application data that has been removed from the content signal.

11. An apparatus as claimed in claim 9 wherein the extraction processor is operable to modify the application data indication of the content signal be associated with the application data stored in the data storage.

12. An apparatus as claimed in claim 11 wherein the extraction processor is operable to modify the application data indication of the content signal to comprise a network server identity through which the application data signal can be accessed.

13. An apparatus as claimed in claim 1 wherein the extraction processor is operable to remove at least some of the application data from the content signal.

14. An apparatus as claimed in claim 1 wherein the apparatus is a digital recording device.

15. An apparatus as claimed in claim 1 is interactive TV data.

16. An apparatus as claimed in claim 1 wherein the extraction processor is operable to store the content signal and the application data in the data storage according to different storage protocols.

17. An apparatus as claimed in claim 1 wherein the apparatus further comprises a communication element for communicating the application data signal and the content signal according to different communication protocols.

18. A method of generating an application data signal; the method comprising receiving an content signal comprising embedded application data;
extracting the application data from the content signal;
storing the content signal and the application data;
generating an application data signal by retrieving the stored application data separately from the content signal.

19. A computer program enabling the carrying out of a method according to claim 18.

20. A record carrier comprising a computer program as claimed in claim 19.
